(19) United States
(12) Patent Application Publication
(10) Pub. No.: US 2013/0086685 A1
(43) Pub. Date: Apr. 4, 2013

(54) SECURE INTEGRATED CYBERSPACE SECURITY AND SITUATIONAL AWARENESS SYSTEM

(71) Applicant: Stephen Ricky Haynes, Sterling, VA (US)

(72) Inventor: Stephen Ricky Haynes, Sterling, VA (US)

(21) Appl. No.: 13/248,114

(22) Filed: Sep. 29, 2011

(51) Int. Cl. G06F 21/00

(52) U.S. Cl. 726/25

(57) ABSTRACT

An integrated cube security system for an organization, such as a governmental or private organization, is disclosed, as well as a method of monitoring security for such an organization against cyberspace vulnerabilities. One such method includes receiving a definition of physical and logical locations of data managed by the organization, and receiving a definition of one or more business rules representing detected circumstances under which the data may be compromised. The method also includes monitoring the data based on the business rules and definition of the physical and logical locations of data to detect a cyberspace or electronic data vulnerability. The method includes generating one or more reports based on monitoring the data and relating at least in part to access of the data, and communicating, via a secure communications module, the one or more reports to an individual included within a community of interest.

### TECHNICAL FIELD

The present disclosure relates generally to a situational awareness system for assessing cyberspace vulnerabilities; in particular, the present disclosure relates to a secure integrated cyberspace security and situational awareness system.

### BACKGROUND

Governments and large corporations are increasingly becoming targets for attacks or unauthorized access of critical assets, such as sensitive data or computing resources. For example, coordinated cyberspace attacks (e.g., “hacking”) has become commonplace, and increasingly is a planned, organized, multiprong event. This may include exploiting vulnerabilities in software to remotely access or corrupt data, or internal “rogue” employees of the government or large corporation attempting to steal or corrupt data. Additionally, sensitive data and other critical computing resources are vulnerable to attacks or events that could cause physical damage to a facility at which the entity's sensitive data is stored (e.g., by an environmental event, terrorist attack, or other unexpected event). In other circumstances, merely an unduly relaxed policy regarding data access may allow data to be accessed by unintended individuals, compromising security for that entity. In still other circumstances, risks of data loss or damage may be due to unforeseen natural events, such as temperature extremes, flooding/drought, or natural disasters. In each of these circumstances, an organization's critical data and computing resources is placed at risk of damage.

Targeted attacks, unauthorized data accesses, or other damaging events can have disastrous effects. For example, because critical resources and infrastructure (e.g., power stations, water treatment plants, airports, governmental regulatory agencies, etc.) use electronic control and monitoring systems, allowing an attacker to access data and networks maintained by such an entity can have substantial negative effects for both that entity and potentially others, for example if control systems are disabled or electronically hijacked.

Software systems exist that allow entities at risk of attack to define known assets and vulnerabilities, and to monitor access to sensitive data or resources that may be a result of an unauthorized access or attack. However, these systems themselves have shortcomings. For example, existing systems may track incoming electronic data access, but would entirely lack any means to determine whether an internal, otherwise-authenticated data access would in fact be unauthorized for some reason (e.g., in the case of a rogue employee or electronic impersonation/hijacking of that individual's profile). Furthermore, existing systems often focus on electronic access methodologies, while ignoring possible physical methods of access which could, without electronic warning, expose the entity to possible damage or compromise of sensitive data storage. Additionally, due to the organizational complexity inherent in governments and other large-scale organizations, it can be difficult and time-consuming to generate a meaningful report by which that entity's vulnerability is communicated. In other words, although a particular security-compromising event or circumstance may even be detected by an existing system, it may take some time for an individual tasked with monitoring for such vulnerabilities to receive notification of that event or circumstance.

In any event, to the extent that electronic communications systems are used for monitoring and reporting possible vulnerabilities of an entity, those communications themselves may be unsecured and subject to interception, allowing a hacker or other entity to gain even more knowledge about the type of security employed by the entity subject to attack. This could lead to a further vulnerability, because an entity may consider itself secure due to diligent monitoring, but is unwittingly teaching external individuals or groups seeking to exploit its data vulnerabilities exactly what is and is not monitored.

For these and other reasons, improvements are desirable.

### SUMMARY

In accordance with the following disclosure, the above and other issues are addressed by the following:

In a first aspect, a method of securing an organization against cyberspace vulnerabilities includes receiving a definition of physical and logical locations of data managed by the organization, and receiving a definition of one or more business rules representing detected circumstances under which the data may be compromised. The method further includes monitoring the data based on the business rules and definition of the physical and logical locations of data to detect a cyberspace or electronic data vulnerability, and generating one or more reports based on monitoring the data and relating at least in part to access of the data. The method also includes communicating, via a secure communications module, the one or more reports to an individual included within a community of interest. The secure communications module cryptographically secures the one or more reports using an encryption key associated with the community of interest.

In a second aspect, a method of operating a security system configured to protect against cyberspace and electronic data vulnerabilities associated with an organization is disclosed. The method includes defining one or more physical and logical locations of data managed by the organization, and defining one or more business rules representing detected circumstances under which the data may be compromised. The method further includes submitting authentication information of a user to personally authenticate the user using credentials uniquely associated with the user, and, upon authentication of the user, establishing a secure communication connection between a computing device operated by the user and a report engine. The secure communication connection provides cryptographic security between the computing device and the report engine and using an encryption key associated with a community of interest including the user. The method further includes receiving, via the secure communication connection, one or more reports based on monitoring the data based on the business rules and definition of the physical and logical locations of data, including information regarding detected cyberspace and electronic data vulnerabilities and encrypted by the encryption key.

In a third aspect, a method of monitoring vulnerability of an organization against cyberspace and electronic data attacks is disclosed. The method includes receiving, via a secure communications module, one or more reports based on monitoring of sensitive data affiliated with an organization and relating at least in part to access of the sensitive data. The sensitive data is monitored across a network affiliated by the organization to detect a cyberspace or electronic data vulnerability, and the one or more reports are communicated to an individual included within a community of interest defined using a secure communications module, the secure communications module cryptographically securing the one or more reports using an encryption key associated with the community of interest.

### BRIEF DESCRIPTION OF THE DRAWINGS

FIG. 1 is an overall schematic view of a network including an organization having data and cyberspace vulnerabilities and configured to monitor for potentially damaging events associated with those vulnerabilities;

FIG. 2 is a block diagram of a monitoring system according to a possible embodiment of the present disclosure;

FIG. 3 is a schematic view of a data footprint an organization implementing aspects of the present disclosure;

FIG. 4 is a schematic diagram of a reporting and extra-organizational collaboration arrangement useable in connection with the present disclosure to provide near-realtime reporting regarding cyberspace and electronic data vulnerabilities;

FIG. 5 is a schematic diagram of an electronic computing device with which aspects of the present disclosure can be implemented;

FIG. 6 is a flowchart of methods and systems for securing an organization against cyberspace and electronic data vulnerabilities, according to a possible embodiment of the present disclosure; and

FIG. 7 is a flowchart of methods and systems for establishing secure communication of reports regarding cyberspace and electronic data vulnerabilities, according to a possible embodiment of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for establishing a secure system for defining, monitoring, detecting, and reporting on electronic data and cyberspace attack vulnerabilities within an organization, such as a government or large corporation. The methods and systems disclosed herein provide a holistic approach to detection and monitoring, by addressing both physical and electronic access to computing systems that would allow an individual to infiltrate a security system of an organization. The methods and systems disclosed herein concurrently provide secured communication of messages among the monitored computing systems, and secured reporting capabilities configurable to control distribution reports, such as security reports, to groups of users having common access rights (i.e., communities of interest). Other advantages and functionalities are provided by the present disclosure as well.

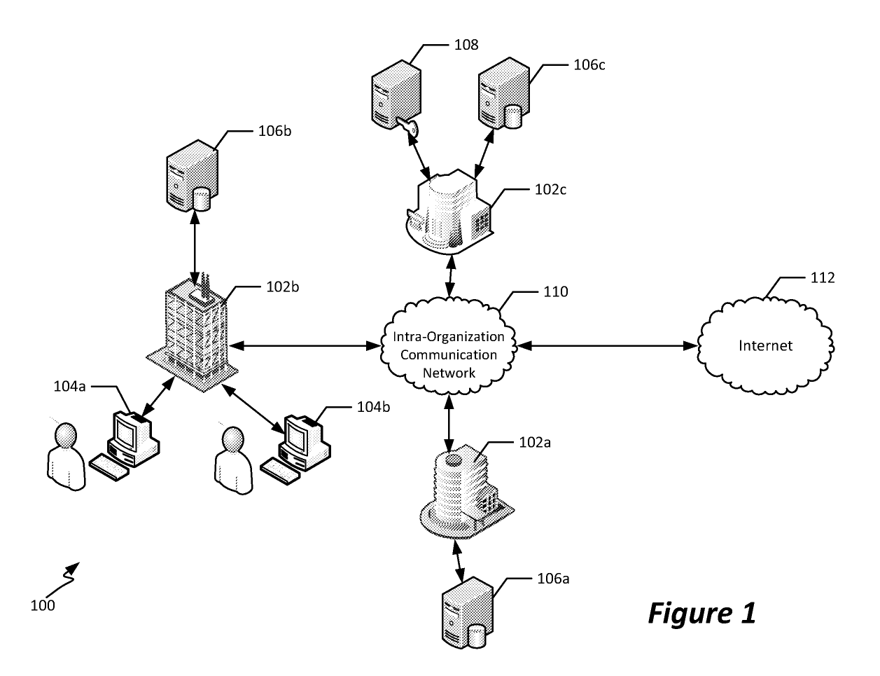

Referring now to FIG. 1, an overall schematic view of a network 100 is shown, including an organization having data and cyberspace vulnerabilities and configured to monitor for potentially damaging events associated with those vulnerabilities. The network 100 generally is distributed across a number of different facilities 102a-c (referred to generally as one or more facilities 102), for example positioned at different physical locations. Each of the different facilities may include different types of computing resources, such as specific or special-purpose computing systems (e.g., computing systems 104a-b), data warehouses (e.g., database servers 106a-c), and authentication systems (e.g., key servers 108). Other different types of computing resources could be included in the network 100 at various facilities 102 as well. The facilities 102a-c are interconnected via an intra-organization communication network 110, and optionally via an external network, shown as the internet 112.

In networked structures such as those shown in FIG. 1, it is recognized that a number of risks, or vulnerabilities, exist via which data or computing systems managed by the organization can be compromised by damage or capture/control. Example vulnerabilities can be based both on physical proximity and compromise of security systems included in computing systems, whether local or remote. For example, a computing system or data warehouse could be vulnerable to damage or theft by an individual having unauthorized physical access to those computing systems. The computing system or data warehouse could be located within a secured portion of a facility 102, but access to that portion of the facility may be compromised due to flaws in security procedures or other reasons. As such, an unauthorized individual may be able to access that secured portion of the facility to damage, steal, or access computing systems and/or data. Alternatively, an unauthorized individual could use one or more pieces of malware to capture login credentials or other authorization credentials from an authorized user affiliated with the organization using the network 100. In such circumstances, that unauthorized individual could access the various computing systems and data warehouses via impersonation of that authorized user at an authentication system (e.g., key server 108), and access data remotely via internet 112. In still further examples, an unauthorized user could simply be located in near proximity to a facility, and can either monitor or access data communicated among authorized users at that facility, for example if the facility were to use an unsecured or compromised wireless network. In still other circumstances, an otherwise authorized user may choose to not follow organization-approved policies relating to security, thereby exposing the organization to data vulnerabilities. In further examples, vulnerabilities of an organization relate not to malicious intent or user noncompliance, but may relate to environmental risks (e.g., natural disasters, power outages, temperature extremes, or other issues that could affect an organization's effectiveness).

In embodiments of the present disclosure, these and other vulnerabilities are addressed by applying a security system that (1) tracks and addresses both physical and logical vulnerabilities of an organization, and (2) secures user authentication processes and data communications, routing data to individuals affiliated with the organization on a secured, authority-level basis. In some embodiments, a global security system can receive a definition of an organization's facilities and computing or data footprint, as well as one or more business rules defining possible events which may indicate that a resource may have been compromised. Such a security system can, in such embodiments, be integrated with secure authentication and secure communication systems such as those provided by Unisys Corporation of Blue Bell, Pa. By combining a secured authentication and communication system with an organization-wide monitoring and situational awareness system, compliance reports can be generated and distributed both within the organization and externally from the organization, to individuals having a demonstrated need for that information, while minimizing a risk of unintentionally exposing sensitive information to unintended individuals.

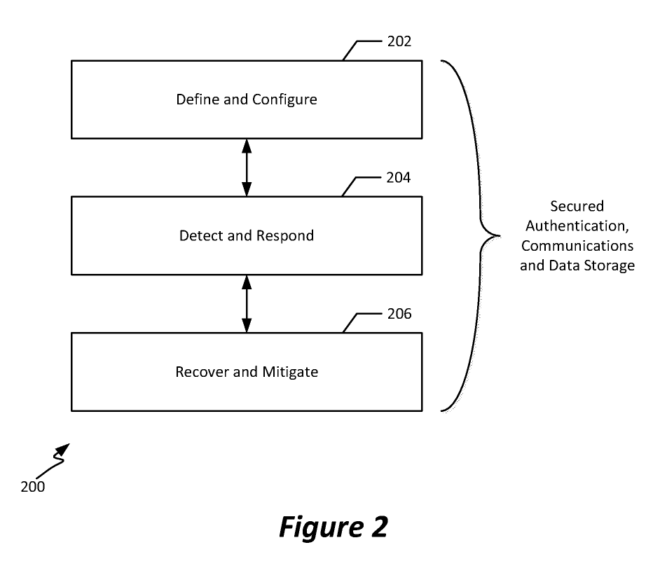

Referring now to FIG. 2, a block diagram of an example monitoring system 200 is illustrated, according to a possible embodiment of the present disclosure. In some embodiments, the example monitoring system 200 can be implemented across an organization, for use in one or more Network Operation Centers (NOCs) and/or Security Operation Centers (SOCs), to monitor organizational compliance with security policies and assess possible vulnerabilities, both in terms of policy violations and areas where a policy may need to be changed/enhanced to address unforeseen vulnerabilities. In such embodiments, the monitoring system 200 can be integrated with communication and authentication security systems as mentioned above. In the embodiment shown, the monitoring system 200 includes a define and configure module 202, a detection and response module 204, and a recover and mitigate module 206.

The define and configure module 202 receives definitions of an organization's physical and logical footprint. By footprint, it is intended that a particular organization's physical locations, as well as physical locations of critical assets of that organization, are tracked, as well as possible physical access points (security points, secured doors, etc.) allowing access to those critical assets. Additionally, the footprint includes logical access points to data and computing resources of the organization, such as network addresses, ports, or other possible addressable locations at which data can be accessed, either from within the organization's internal network or external to that network (e.g., via the internet).

In certain embodiments, the define and configure module 202 also receives one or more business rules defining circumstances in which critical assets, such as data or computing resources of the organization, may become vulnerable, and optionally the source of such vulnerabilities. For example, as mentioned above, physical access to a critical asset will leave that asset vulnerable to physical damage, and may also, depending upon circumstances, subject that asset to theft or copying. Logical or data access to the same asset may leave that asset vulnerable to deletion (unless backup copies exist) as well as copying. Some example vulnerabilities include physical accidents (vehicle accidents, chemical spills, etc.), infrastructure failures (power, water, HVAC, computing systems), human factors (illness, substance abuse, theft, terrorism, vandalism, sabotage, espionage, human error etc.) or natural disasters (e.g., floods, temperature extremes, earthquakes, etc.).

Applying business rules to these various situations, particular observed occurrences will be related to each possible vulnerability, and optionally an action to be taken in response. In some specific examples, the business rules define circumstances which likely signify such access by an unauthorized individual such as a rogue employee, hacker, or saboteur. The business rules can define, for example, alerts in case of physical access to facilities at non-standard hours or access attempts by an otherwise authorized user to a number of critical assets unrelated to that user's job function. Either of these circumstances may indicate that a user's identification is being copied, or that the user has malicious intent regarding the organization's critical assets. In another example, alerts could be generated based on remote access attempts to an organization's intranet, or for particular data files or computing resources. In a further example, alerts could be generated based on the presence of a wireless computing device or its attempt to connect to or intercept data communicated via an organization's wireless network. Other example business rules could be defined as well, for example to set thresholds for numbers and types of data access that would constitute suspicious activity, or other rules to define an event for which an alert to security personnel should be generated. In a further example, various industry standards could be included as part of the business rules (e.g., National Institute of Standards and Technology (NIST), International Organization for Standardization (ISO), Control Objectives for Information and Related Technology (CobiT), etc.) to define a particular predefined “acceptable” operational state.

In various embodiments, both the definitions of the organization and the business rules can be defined either on a site-by-site basis or based on emergency type. Other organizational schemes could be used as well.

The detection and response module 204 monitors access of critical assets by employees and other users affiliated with the organization. The detection and response module 204 also allows a user to define one or more response plans associated with each possible identified alert indicating a possible vulnerability of a critical asset, such as a data or computing system resource. The response plan can include one or more response reactions available to an organization, including simply logging the alert, deploying security personnel, tracking and/or logging subsequent data accesses of the same or similar resources to detect access patterns, and/or blocking subsequent data or physical access to resources upon detecting a possible vulnerability. Other actions are possible as well.

Optionally, the detection and response module 204 can include response testing and other functionalities that would allow a user to determine effectiveness of a particular set of business rules, alerts, and appropriate responses. In some circumstances, based on such testing, additional definition of a data or organizational footprint, additional business rules, or additional response cases might be defined, for example to account for unforeseen vulnerabilities of critical assets.

The recover and mitigate module 206 coordinates recovery from possible vulnerabilities of critical assets after a security violation has been detected. The specific tasks performed by the recover and mitigate module 206 will vary greatly depending upon the particular vulnerability or violation detected. Example recovery tasks can include restoring data that was included on stolen or damaged hardware, freezing accounts and/or requiring users to change passwords or other authentication data, disabling or changing security settings relating to particular computing systems or networks. In addition, the recover and mitigate module 206 identifies areas for improvement of monitoring processes and improvements in security to improve responsiveness to security threats.

In certain embodiments, the recover and mitigate module 206 generates reports of data either periodically or in response to a particular event (either user generated or automatically, as defined by one or more business rules). The reports can include, for example, summaries of data accesses or numbers of vulnerabilities identified and exposed, summaries or detailed reports of cube-attacks, or access attempts from external to the organization. These reports can be tailored to particular audiences. For example, a report including detailed information regarding specific vulnerabilities can be reported internally to a security team responsible for responding to possible threats, but would be inappropriate to report to all of the organization's employees, or to the public in general. A high-level report including an index of generalized readiness could be generated as a dashboard viewable by high-level individuals within or external to the organization. A generalized report summarizing a successfully thwarted cube-attack, however, could be reported to a news organization or other group for general dissemination. In accordance with the present disclosure, the security and monitoring system 200 can be integrated with secure communications software, such as Stealth and Trusted Identities software packages from Unisys Corporation of Blue Bell, Pa., to ensure that only authorized individuals receive reports generated by the system 200. In some embodiments, the monitoring system 200 can be implemented at least in part using the CSR3 software package provided by Avineon, Inc. of Alexandria, Va. Other types of monitoring systems could be used as well.

In various embodiments, the define and configure module 202, detection and response module 204, and recover and mitigate module 206 execute in parallel, in that detection and monitoring occurs concurrently with definition of new assets, threads, and vulnerabilities, and reporting/mitigation can also occur concurrently with both of these other tasks. In certain embodiments, one or more modules or tasks performed by those modules can be scheduled for execution or updating on a periodic or other scheduled basis, such that at times one or more of the modules may or may not be executing concurrently with other modules.

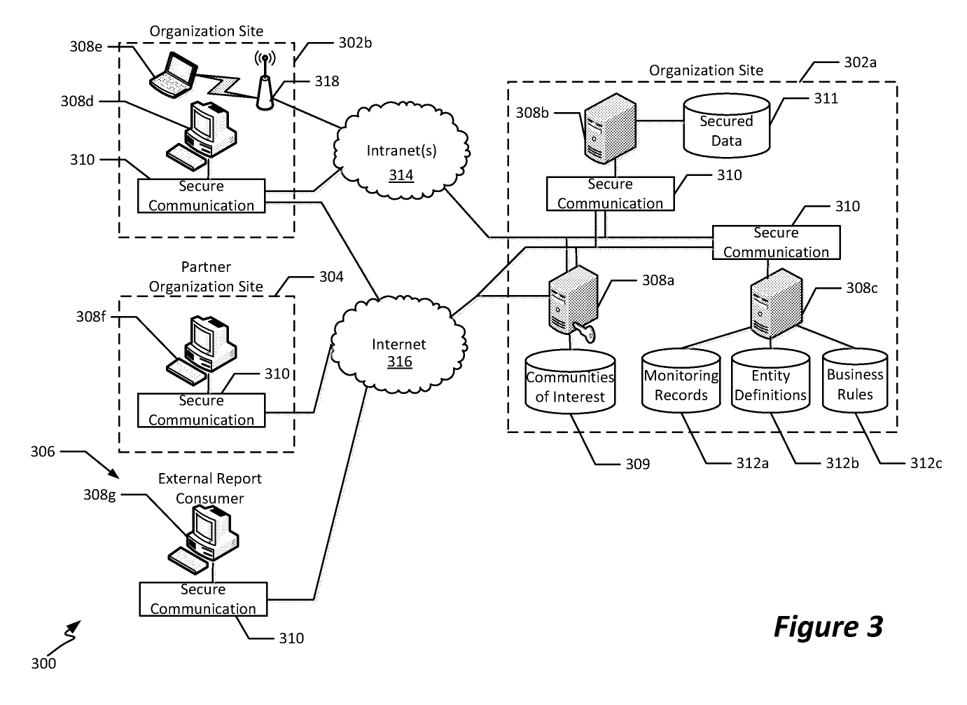

Referring now to FIG. 3, a schematic view of a footprint 300 of an organization implementing aspects of the present disclosure is shown. The footprint 300 can include a plurality of locations both within and external to the organization, shown as internal locations 302a-b, partner location 304, and external location 306 (collectively, referred to as “locations”). Each of the locations, in the embodiment shown, has both physical and logical locations, in that each location includes one or more computing systems accessible either (1) physically, for example by a user affiliated with the organization, allowing that user to access various data and computing resources within the organization's footprint 300, or (2) electronically, for example by a user or third party external or internal to, or remote from, the organization. In some embodiments, the footprint 300 can represent multiple, interrelated organizations.

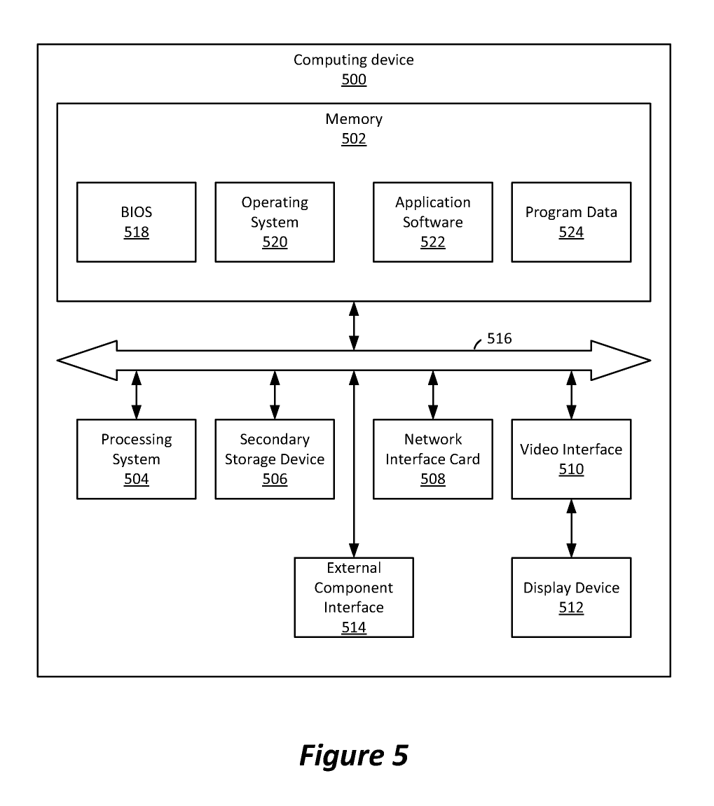

In the embodiment shown, the footprint 300 includes computing systems 308 dispersed across the locations affiliated with the organization. In this example, a first location 302a has three computing systems 308a-c, second location 302b has two computing systems 308d-e, partner location 304 has a computing system 308f, and an external location 306 is associated with a computing system 308g. Each of these computing systems can take a variety of forms, for example desktop or mobile computing systems, or server systems. An example of hardware and software that can be included in such computing systems is described below in connection with FIG. 5. Although in the embodiment shown a particular arrangement of computing systems is shown, it is understood that other arrangements of computing systems could be used as well.

In the footprint 300, and in connection with the methods and systems described herein for providing a security and management system that provides data security among the various locations, each of the computing systems that are authorized to access data of the organization include a secure communication module 310 installed thereon. The secure communication module 310 cooperates with other secure communication modules 310 (and other computers directly) to establish and manage secure connections to other computing systems.

In one possible embodiment of the present invention, this secure connection utilizes a security technology developed by the Unisys Corporation that are described in detail in a number of commonly assigned U.S. patent applications. These applications generally describe a cryptographic splitting and recombining arrangement referred to herein as “cryptographically secure” or “Stealth-enabled”. These applications include:
1. U.S. Provisional Application entitled: Distributed Security on Multiple Independent Networks using Secure “Parsing” Technology, by Robert Johnson, attorney Docket No. TN400.P, Ser. No. 60/648,531, filed Jan. 31 , 2005;
2. U.S. Application entitled: Integrated Multi-Level Security System, by Robert Johnson, Attorney Docket No. TN400. U.S. Ser. No. 11/339,974 filed Jan. 26, 2006 claiming the benefit of the above provisional applications;
3. U.S. Application entitled: Integrated Multi-Level Security System, by Robert Johnson et al., Attorney Docket No. TN400.USCIP1, Ser. No. 11/714,590 filed Mar. 6, 2007 which is a continuation-in-part of U.S. application Ser. No. 11/339,974;
4. U.S. Application entitled: Integrated Multi-Level Security System, by Robert Johnson et al., Attorney Docket No. TN400.USCIP2, Ser. No. 11/714,666 filed Mar. 6, 2007 which is a continuation-in-part of U.S. application Ser. No. 11/339,974; and
5. U.S. Application entitled: Integrated Multi-Level Security System, by Robert Johnson et al., Attorney Docket No. TN400.USCIP3, Ser. No. 11/714,598 filed Mar. 6, 2007 which is a continuation-in-part of U.S. application Ser. 11/339,974.
6. U.S. Application entitled: Methods and Systems for Providing and Controlling Cryptographic Secure Communications Across Unsecured Networks, by Robert Johnson et al., Attorney Docket No. TN533A, Ser. No. 13/105,141 filed May 11, 2011

All of these applications are currently pending before the U.S. Patent and Trademark Office, are commonly assigned to the owner of the instant application, and are incorporated herein in their entireties.

In general, the secure communication module 310 can coordinate receipt, authentication and provision of security data (e.g., passwords, biometric data, encryption/decryption keys, etc.). In some embodiments, the secure communication module 310 implements a cryptographic splitting data security architecture in which data packets passed between computing systems include data which has been encrypted and split across data packets. For example, in some embodiments, each file or data set is encrypted with an encryption key associated with a particular community of interest, and is combined within a data packet with other, unrelated encrypted portions of data files or data sets.

Encryption keys specific to a particular user or group of similarly situated users (i.e., a “community of interest”), can be managed within the footprint 300 of the organization by one or more authentication systems, such as computing system 308a at site 302a. In the embodiment shown, the first computing system 308a provides authentication of users affiliated with the organization, and stores community of interest information 309, which includes encryption keys specific to a community of interest. One or more encryption keys associated with a community of interest can be provided to a user for secure communication among the various computing systems within the footprint 300 of the organization.

In the embodiment shown, the first site 302a includes a second computing system 308b which is configured to retain secured data 311. The secured data can represent any of a variety of types of sensitive data intended to be maintained as confidential within the organization. By confidential, it is intended that access to the secured data 311 be limited to only individuals affiliated with the organization, or in some cases, to only a predefined subset of those individuals (e.g., a community of interest). Example types of secured data 310 can include data tracking security of the organization (e.g., data collected using the CSR3 software package provided by Avineon, Inc. of Alexandria, Va.), or other types of sensitive data, such as organizational confidential information. In such embodiments, the secured data 311 can optionally be managed and stored using a cryptographically split arrangement in which data is distributed across a number of physical and/or logical disks.

In one possible embodiment of the present invention, the secured data 310 also utilizes the above-described, Stealth technology developed by Unisys Corporation of Blue Bell, Pa. Additional applications describing methods of storing data in cryptographically split portions include:

U.S. patent application Ser. No. 12/272,012, entitled “BLOCK LEVEL DATA STORAGE SECURITY SYSTEM”, filed Nov. 17, 2008, Attorney Docket No. T497.

U.S. patent application Ser. No. 12/336,558, entitled “DATA RECOVERY USING ERROR STRIP IDENTIFIERS”, filed Dec. 17, 2008, Attorney Docket No. TN494.

U.S. patent application Ser. No. 12/336,559 entitled “STORAGE SECURITY USING CRYPTOGRAPHIC SPLITTING”, filed Dec. 17, 2008, Attorney Docket No. TN496.

U.S. patent application Ser. No. 12/336,562, entitled “STORAGE SECURITY USING CRYPTOGRAPHIC SPLITTING”, filed Dec. 17, 2008, Attorney Docket No. TN496A.

U.S. patent application Ser. No. 12/336,564, entitled “STORAGE SECURITY USING CRYPTOGRAPHIC SPLITTING”, filed Dec. 17, 2008, Attorney Docket No. TN496B.

U.S. patent application Ser. No. 12/336,568, entitled “STORAGE SECURITY USING CRYPTOGRAPHIC SPLITTING”, filed Dec. 17, 2008, Attorney Docket No. TN504A.

U.S. patent application Ser. No. 12/342,438 entitled “STORAGE AVAILABILITY USING CRYPTOGRAPHIC SPLITTING”, filed Dec. 23, 2008, Attorney Docket No. TN495.

U.S. patent application Ser. No. 12/342,464 entitled “STORAGE AVAILABILITY USING CRYPTOGRAPHIC SPLITTING”, filed Dec. 23, 2008, Attorney Docket No. TN495A.

U.S. patent application Ser. No. 12/342,547 entitled “STORAGE OF CRYPTOGRAPHICALLY-SPLIT DATA BLOCKS AT GEOGRAPHICALLY-SEPARATED LOCATIONS”, filed Dec. 23, 2008, Attorney Docket No. TN493.

U.S. patent application Ser. No. 12/342,523 entitled “RETRIEVAL OF CRYPTOGRAPHICALLY -SPLIT DATA BLOCKS FROM FASTEST-RESPONDING STORAGE DEVICES “, filed Dec. 23, 2008, Attorney Docket No. TN493A.

U.S. patent application Ser. No. 12/342,500 entitled “BLOCK-LEVEL DATA STORAGE USING AN OUTSTANDING WRITE LIST”, filed Dec. 23, 2008, Attorney Docket No. TN493B.

The present disclosure is related to commonly assigned, and concurrently filed, U.S. patent application Ser. No. 12/342,636 entitled “STORAGE COMMUNITIES OF INTEREST USING CRYPTOGRAPHIC SPLITTING”, filed Dec. 23, 2008,

U.S. patent application Ser. No. 12/342,575 entitled “STORAGE COMMUNITIES OF INTEREST USING CRYPTOGRAPHIC SPLITTING”, filed Dec. 23, 2008, Attorney Docket No. TN498A.

U.S. patent application Ser. No. 12/342,610 entitled “STORAGE COMMUNITIES OF INTEREST USING CRYPTOGRAPHIC SPLITTING”, filed Dec. 23, 2008, Attorney Docket No. TN498B.

U.S. patent application Ser. No. 12/342,379 entitled “SECURE NETWORK ATTACHED STORAGE DEVICE USING CRYPTOGRAPHIC SPLITTING”, filed Dec. 23. 2008, Attorney Docket No. TN499.

U.S. patent application Ser. No. 12/342,414 entitled “VIRTUAL TAPE BACKUP ARRANGEMENT USING CRYPTOGRAPHICALLY SPLIT STORAGE”, filed Dec. 23, 2008, Attorney Docket No. TN508.

U.S. patent application Ser. No. 12/346,578 entitled “SIMULTANEOUS STATE-BASED CRYPTOGRAPHIC SPLITTING IN A SECURE STORAGE APPLIANCE”, filed Dec. 30, 2008, Attorney Docket No. TN505.

All of these applications are currently pending before the U.S. Patent and Trademark Office, are commonly assigned to the owner of the instant application, and are incorporated herein in their entireties.

In various embodiments, and according to the embodiments of the Stealth Data-at-Rest embodiments described in the applications listed above, the secured data 311 can be managed by a plurality of computing systems rather than at a single computing system 308b, and can be managed at a number of locations as well. The single computing system 308b is illustrated for simplicity, but is not intended to be limiting.

A third computing system 308c is configured to manage security software used to assess organizational vulnerabilities, which can in turn be secured using Stealth-enabled communication and data storage systems as described above. In the embodiment shown, the third computing system 308c executes the CSR3 software package provided by Avineon, Inc. of Alexandria, Va. or some equivalent software package, and stores data affiliated with organizational security. In one possible embodiment the data affiliated with organizational security includes monitoring records 312a, entity definitions 312b, and business rules 312c. The monitoring records 312a represent observed events occurring within the footprint of the organization, either at an organization-wide level or on a facility-specific level. Example events included in the monitoring records 312a can include, for example: records of data accesses or access attempts from unknown users or particular users affiliated with the organization or from a computing system external to the organization (e.g., computing system 308g); physical events occurring at a particular location, such as keycard access to a restricted area of a particular facility; or other potential points of electronic or physical exposure to a data/computing system vulnerability. The entity definitions 312b include user-entered parameters defining the footprint of the organization, such that the management and security software is aware of the various types of possible events that should be monitored and logged. The entity definitions 312b include, for example, locations of and connections available to computing equipment, hierarchical or security classifications within the organization and associated physical and electronic access rights; location access rights; electronic data usage patterns, and other types of information capable of defining an organization or its typical operation. The business rules 312c define the circumstances in which, based on the entity definitions 312b and monitoring records 312a, a possible vulnerability may be exposed. The business rules 312c can take any of a variety of forms, and generally include defined actions (e.g., generation of alerts and/or reports) in response to detection of one or more events raising the possibility of compromising security. Example business rules 312c can define an alarm to be transmitted to one or more particular users in case of unauthorized access (physical or electronic) to computing systems and/or data within the footprint 300, or can define one or more mitigation steps taken to prevent damage in response to a detected possible security concern. Other types of business rules could be included as well.

Within the footprint 300, other locations besides location 302a can include computing resources of varying types. In the embodiment shown, second location 302b includes a computing system 308d capable of communicating with any of the computing systems 308a-c via intranet 314 or internet 316. Because computing system 308d is depicted as having an associated secure communication module 310, it is assumed that authorized users affiliated with the organization can provide credentials to the computing system 308d, which can optionally be communicated to computing system 308a for authentication. In some circumstances, the user authentication systems used to accomplish unique, personal authentication of each user affiliated with an organization can include Unisys Trusted Identities software package from Unisys Corporation of Blue Bell, Pa. Other software packages capable of personal authentication could be used as well.

In the embodiment shown, location 302b includes a further computing system, illustrated as computing system 308e. This computing system 308e lacks a secure communication module 310, and is intended to represent an unauthorized computing system attempting to connect to or view data travelling within networks within the organization's footprint 300. In an example arrangement the computing system 308e attempts to establish communication with and access to data within the footprint 300 via a wireless network connection 318 available at location 302b. If the computing system 308e is used by an authorized user affiliated with the organization, the computing system 308e may be granted access to data throughout the organization according to the particular identity of the user. As previously discussed, the particular data available to a particular user can be defined by the one or more communities of interest with which the user is associated. In certain embodiments, attempts to access data that is not allowed for users within the community or communities of interest associated with the user are logged by security software, for example to catalog patterns of unauthorized access or attempted access to sensitive data.

If the computing system 308e is not associated with or used by an authorized user, in some embodiments security software will detect that the computing system is attempting to connect to a local network of the organization or to access secured data 311. For example, the computing system 308e could be a notebook, tablet, or handheld computing device capable of wireless communication, and could be used to attempt to connect to the organization's network. In such embodiments, wireless environmental assessment tools can be incorporated into the security software to detect wireless access threats. In some embodiments, wireless environmental assessment and monitoring systems can include the Wireless Zone Defense software suite provided by AirPatrol Corporation of Columbia, Md. Other types of wireless assessment and monitoring software packages could be incorporated as well, in addition to other types of environmental monitoring software.

External locations affiliated with the organization can be used to either (1) access data or computing resources controlled or managed by the organization, and (2) receive reports from the organization based on detected vulnerabilities or accesses occurring within the footprint 300 of the organization. In the embodiment shown, a partner location 304 includes one or more computing systems (shown as computing system 308f). Authorized computing systems at a partner location 304 (e.g., a different but affiliated organization) can be configured to include a security module 310 and can communicate with and access data within the footprint 300 of the organization. Likewise, computing systems at an external location 306 (e.g., shown as computing system 308g) can be used as well to receive reports or access other types of data associated with the organization, according to the predefined rules set by the security software of the organization and the access rules defined by the communities of interest topology specified for that organization. For example, in some embodiments, a particular community of interest can be defined for users at an external location 306 allowing those users to view reports generated by the security software, for example to allow assessment of security events by multiple entities.

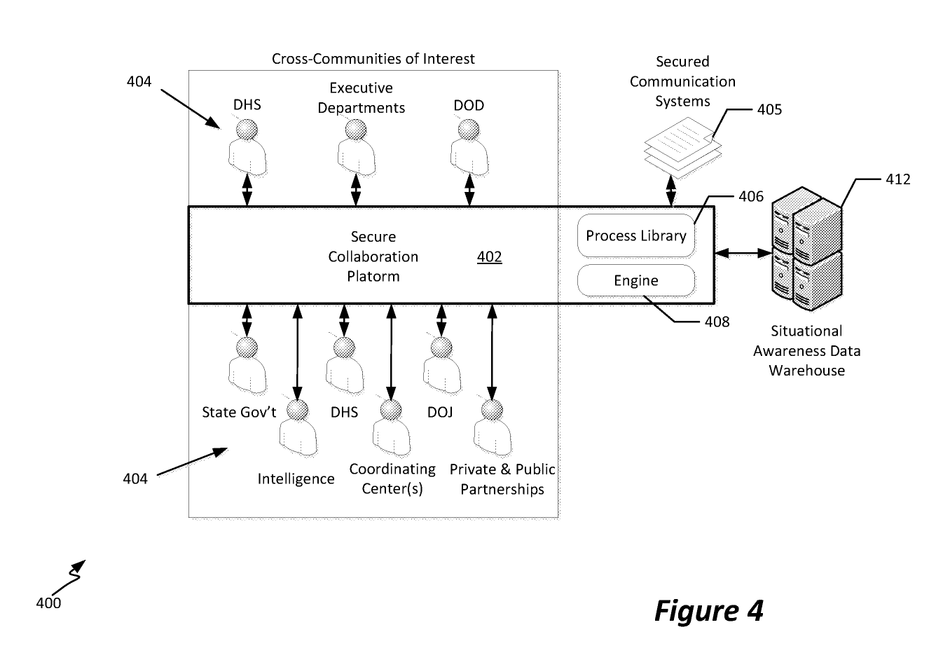

FIG. 4 is a schematic diagram of a reporting arrangement 400 useable in connection with the present disclosure to provide near-realtime reporting regarding cyberspace and electronic data vulnerabilities, in conjunction with the arrangements discussed above in connection with FIGS. 1-3. Where the arrangements discussed above in connection with FIGS. 1-3 relate to specific computing systems and locations associated with an organization, it is understood that the reporting arrangement 400 can be based on information gathered relating to one or more such organizations, and can distribute reports and other information to authorized individuals both within and external to an organization. Rather than basing access rights on an individual's role within an organization (or location within an organization) administered by that organization's network, use of a collaborative software system and associated platform-wide security infrastructure allows validation of users and secure, realtime or near-realtime sharing of organizational status information with a configurable set of individuals.

The reporting arrangement 400 includes a collaboration platform 402 within which security information can be defined, collected, and/or stored. Generally, the collaboration platform 402 allows for data sharing across two or more organizations to allow for data sharing based not upon the user's direct reporting arrangement with the organization, but based instead upon the user's membership within a group of similarly situated individuals. As such, each of the users can either submit or access data of an organization may be affiliated with the organization, in that the users may be previously approved to access data associated with the organization, but need not report directly into the organization. As such, and as discussed in further detail below, users can be associated with communities of interest to control information flow, at least with respect to sensitive data of an organization, with each community of interest representing a particular security classification.

In certain embodiments, the collaboration platform 402 includes a combination of software packages, such as the security software and the secured communications modules described above in connection with FIG. 3. Other software, such as the wireless environmental assessment software and identity authentication software described above, can be included as well.

In the embodiment shown, the collaboration platform 402 is accessible by various entities within and external to an organization. In the embodiment shown, the collaboration platform 402 is used by an organization having a governmental affiliation, such that various government entities have an interest in the security of and data managed by the organization. An example organization in which the collaboration platform 402 can be implemented might be, for example, a government agency charged with managing sensitive infrastructure (e.g., waterways, power plants, power grid, or other resources), such as the Department of Homeland Security, the Department of Energy, or other analogous organization.

In the embodiment shown, the collaboration platform is accessible by a plurality of users grouped by communities of interest (collectively and individually referenced as communities of interest 404). In such an embodiment, a user affiliated with a particular community of interest can provide trusted identification information (e.g., biometric data) to authentication software (e.g., Trusted Identities software, as described above). The user can then be assigned to one or more communities of interest 404 based on that user's particular role with the organization or one of its affiliates. In the example shown, various intra-governmental and extra-governmental entities are illustrated, both within and external to the organization being monitored. As described above, the various communities of interest can be defined and managed within a Stealth secure data and software system 405 developed by Unisys Corporation of Blue Bell, Pa.

The collaboration platform 402 includes a process library 406 and an engine 408. The process library 406 includes a listing of operations performed by the collaboration platform 402, including monitoring the organizations footprint (e.g., footprint 300 of FIG. 3) for data or electronic vulnerabilities, performing tests of the generating reports and/or dashboards illustrating access or vulnerability statistics. The process library 406 can be configured to include, for example, various predefined processes, such as methods of managing communication among entities associated with the collaboration platform. In various embodiments, the process library 406 includes definitions of process roles, risk or vulnerability mitigation strategies, communication links, risk evaluation and response coordination, and management of risk mitigation and associated vulnerability alerts and/or exceptions to those alerts. In certain embodiments, the process library can be defined, in whole or part, within the entity definitions 312b and business rules 312c illustrated above in conjunction with FIG. 3.

In the embodiment shown, the engine 408 executes tasks based on the definitions included in the process library to monitor the organization. The engine manages access to and data storage in a situational awareness data warehouse 410, which receives data defined by monitoring processes of the engine 408

Overall, regarding data access and reporting, the collaboration platform 402 allows access to data and/or reports defining near-realtime threats or security vulnerabilities detected based on information included in the situational awareness data warehouse 410. The data and/or reports can be accessed by various types of entities, shown as communities of interest 404, which are each defined to be allowed access to particular reports of interest to that community.

In some embodiments, external entities are allowed access to non-confidential or redacted versions of status reports or event reports, while communities of interest including internal users are provided greater levels of access (optionally, with individuals having different security clearance levels having different levels of data access and corresponding different memberships in communities of interest 404). In other embodiments, both internal and external entities are allowed access to data “even-handedly”, such that all individuals, regardless of whether they are a part of the organization, are provided data according to that particular individual's security access rights or security clearance level. In such an embodiment, the communities of interest 404 can be defined as particular security clearance levels across both internal and external users, with each class or security level of individuals allowed to access different types of different classifications of data. Additionally, the data in the situational awareness data warehouse 410 can be segmented or isolated using a Stealth-enabled storage segmentation and cryptographic arrangement, thereby preventing unauthorized access of the data by non-authorized users or administrators of the overall arrangement 400.

Using the arrangement 400 within an organization's footprint 300, and within various footprints of multiple affiliated organizations, it is possible for that organization or organizations to quickly parse possible vulnerabilities and communicate those vulnerabilities to relevant individuals across an entire organization or across multiple organizations. This allows for a more global view on the types of cube-attacks or data vulnerabilities that may be exposed in one or more organizations, which allows for (1) quicker detection of and mitigation from organized, widespread cube-attacks or data vulnerabilities and (2) quicker recognition of targeted attacks of a particular organization and other locations where similar attacks may take place in that organization or other similarly situated organizations across which data is shared using the collaboration platform 402. Other advantages are apparent from the present disclosure as well.

FIG. 5 is a block diagram illustrating an example computing device 500, which can be used to implement aspects of the present disclosure. In particular, the computing device 500 can be used within an organization to manage or store data, and can be used to operate a portion of a monitoring system and/or secured communication module as described above, or to form a portion of the collaboration platform 402 of FIG. 4.

In the example of FIG. 5, the computing device 500 includes a memory 502, a processing system 504, a secondary storage device 506, a network interface card 508, a video interface 510, a display unit 512, an external component interface 514, and a communication medium 516. The memory 502 includes one or more computer storage media capable of storing data and/or instructions. In different embodiments, the memory 502 is implemented in different ways. For example, the memory 502 can be implemented using various types of computer storage media.

The processing system 504 includes one or more processing units. A processing unit is a physical device or article of manufacture comprising one or more integrated circuits that selectively execute software instructions. In various embodiments, the processing system 504 is implemented in various ways. For example, the processing system 504 can be implemented as one or more processing cores. In another example, the processing system 504 can include one or more separate microprocessors. In yet another example embodiment, the processing system 504 can include an application-specific integrated circuit (ASIC) that provides specific functionality. In yet another example, the processing system 504 provides specific functionality by using an ASIC and by executing computer-executable instructions.

The secondary storage device 506 includes one or more computer storage media. The secondary storage device 506 stores data and software instructions not directly accessible by the processing system 504. In other words, the processing system 504 performs an I/O operation to retrieve data and/or software instructions from the secondary storage device 506. In various embodiments, the secondary storage device 506 includes various types of computer storage media. For example, the secondary storage device 506 can include one or more magnetic disks, magnetic tape drives, optical discs, solid state memory devices, and/or other types of computer storage media.

The network interface card 508 enables the computing device 500 to send data to and receive data from a communication network. In different embodiments, the network interface card 508 is implemented in different ways. For example, the network interface card 508 can be implemented as an Ethernet interface, a token-ring network interface, a fiber optic network interface, a wireless network interface (e.g., Wi-Fi, WiMax, etc.), or another type of network interface.

The video interface 510 enables the computing device 500 to output video information to the display unit 512. The display unit 512 can be various types of devices for displaying video information, such as a cathode-ray tube display, an LCD display panel, a plasma screen display panel, a touch-sensitive display panel, an LED screen, or a projector. The video interface 510 can communicate with the display unit 512 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 514 enables the computing device 500 to communicate with external devices. For example, the external component interface 514 can be a USB interface, a FireWire interface, a serial port interface, a parallel port interface, a PS/2 interface, and/or another type of interface that enables the computing device 500 to communicate with external devices. In various embodiments, the external component interface 514 enables the computing device 500 to communicate with various external components, such as external storage devices, input devices, speakers, modems, media player docks, other computing devices, scanners, digital cameras, and fingerprint readers.

The communications medium 516 facilitates communication among the hardware components of the computing device 500. In the example of FIG. 5, the communications medium 516 facilitates communication among the memory 502, the processing system 504, the secondary storage device 506, the network interface card 508, the video interface 510, and the external component interface 514. The communications medium 516 can be implemented in various ways. For example, the communications medium 516 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 502 stores various types of data and/or software instructions. For instance, in the example of FIG. 5, the memory 502 stores a Basic Input/Output System (BIOS) 518 and an operating system 520. The BIOS 518 includes a set of computer-executable instructions that, when executed by the processing system 504, cause the computing device 500 to boot up. The operating system 520 includes a set of computer-executable instructions that, when executed by the processing system 504, cause the computing device 500 to provide an operating system that coordinates the activities and sharing of resources of the computing device 500. Furthermore, the memory 502 stores application software 522. The application software 522 includes computer-executable instructions, that when executed by the processing system 504, cause the computing device 500 to provide one or more applications. The memory 502 also stores program data 524. The program data 524 is data used by programs that execute on the computing device 500.

Although particular features are discussed herein as included within an electronic computing device 500, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR5 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

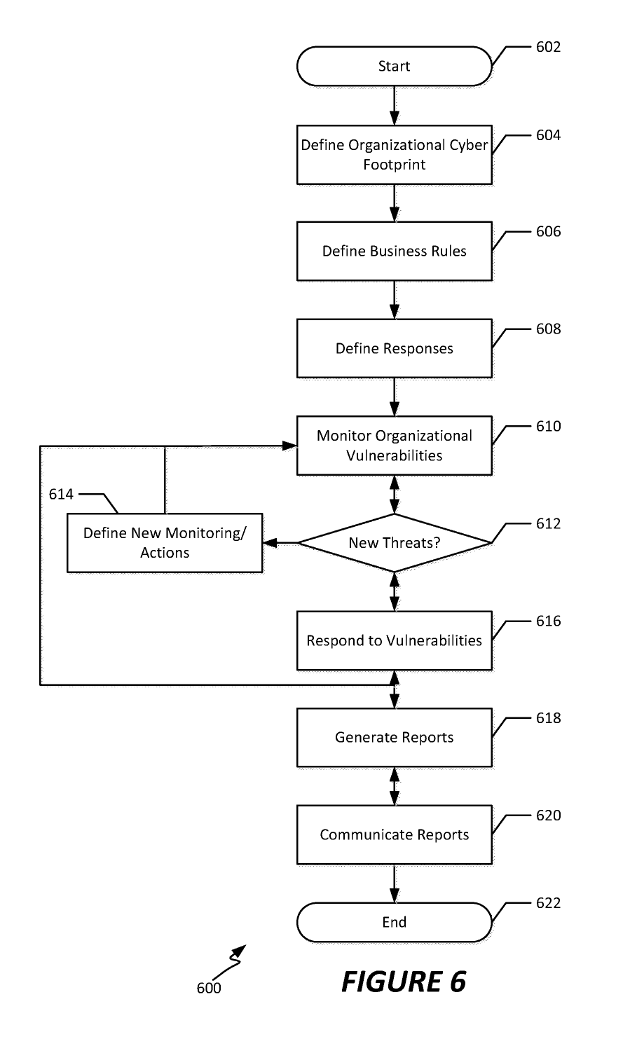

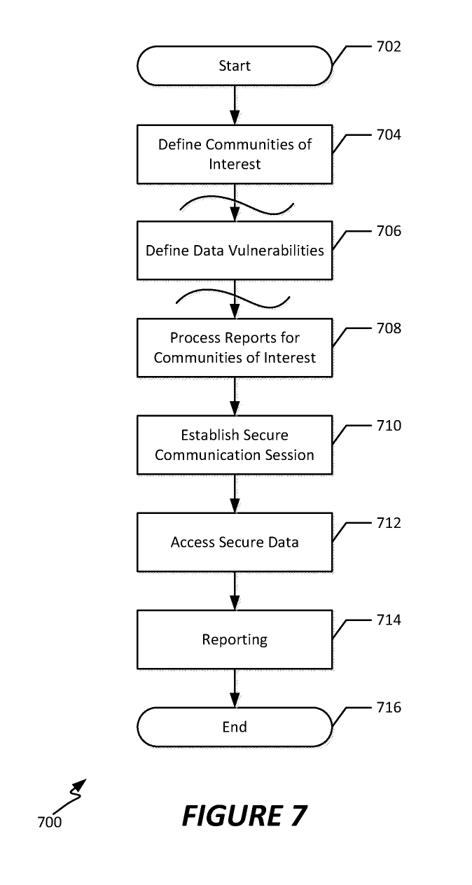

Now referring to FIGS. 6-7, flowcharts of methods and systems that implement aspects of the above-described overall arrangement for global monitoring and response to cyberspace and electronic data vulnerabilities are discussed. In general, the methods and systems discussed herein can be implemented within a collaboration platform, such as collaboration platform 402 of FIG. 4.

Referring now to FIG. 6, a method 600 for securing an organization against cyberspace and electronic data vulnerabilities is disclosed, according to a possible embodiment of the present disclosure.

The method 600 is initiated at a start operation 602, which corresponds to installation of security software, as well as secure communications systems across an organization's footprint and optionally across multiple, affiliated organizations, to allow shared data in realtime or near-realtime with individual users having a predetermined security clearance level. A footprint definition operation 604 corresponds to defining an organizational footprint of one or more organizations to be monitored by the security software. In certain embodiments, the definition operation 604 is performed by a user associated with the organization, using the security software, to define physical and electronic or logical locations and access points to a computing network of the organization, such that physical and electronic vulnerabilities can be detected. In certain embodiments, the definition operation 604 allows a user to enter definitions included in the entity definitions associated with a particular footprint, such as the entity definitions 312b of footprint 300 described above in conjunction with FIG. 3.

A business rule definition operation 606 allows a user to define one or more business rules defining monitoring operations, as well as instances in which vulnerabilities are exposed, such as cyberspace attacks, unauthorized user access to organizational data, environmental threats, unauthorized wireless communication in protected areas, or damage to physical facilities associated with the organization. Other vulnerabilities, of business rules for detecting such vulnerabilities, are possible as well.

A response definition operation 608 allows the user to define planned responses to detected vulnerabilities. For example, the response definition operation 608 can define a series of acts to take in response to a detected cyberspace attack, including for example, logging data access attempts and internet addresses (e.g., IP addresses) from which such data access attempts are made; logging the data attempted to be accessed, generating an alert to one or more predefined users of a particular security level (e.g., a community of interest), enabling a locking mechanism to limit access to the vulnerable systems/equipment, shutting down or suspending operation of computing equipment, or taking such equipment “offline” or other actions. Other responses could be defined as well, and can be defined on a per-vulnerability, per attack, or per-class of attacks basis. In certain embodiments, the response definition operation 608 allows a user to further define portions of business rules, such as rules 312c described above in connection with FIG. 3.

A monitoring operation 610 operates generally concurrently with other operations discussed in connection with the overall method 600, and monitors operation and access to an organization's computing resources (i.e., access to that organization's footprint). In certain embodiments, the monitoring operation 610 generates a log of data or computing system accesses, and stores that data to ultimately (1) determine abnormal access patterns (e.g., based on the business rules defined above), and (2) generate reports of both “normal” and unexpected or suspicious access activity (as described below). For example, existing known threats and future threats could be monitored, and security policies adjusted accordingly, with respect to technical, physical, or electronic controls to protect against internal or external attacks. In certain embodiments, the monitoring operation 610 securely stores a record of access to the organization's data in monitoring records, such as monitoring records 312a of FIG. 3, or within a situational awareness data warehouse, such as warehouse 410 of FIG. 4. For example, the monitoring operation 610 can use a Stealth-enabled storage system to store split and encrypted shares of data across one or more pieces of computing hardware (disks, computing systems, etc.)

A threat assessment operation 612 operates generally concurrently with the monitoring operation 610, and determines, based on the monitoring records generated by the monitoring operation 610, whether any new threats may possibly be exposed. The threat assessment operation 612 therefore determines whether any activity reflected in the monitoring operation 610 is somehow inadequate to detect a vulnerability, for example due to hardware changes or due to inadequate business rule definitions.

If the threat assessment operation 612 determines that new threats exist, a new monitoring action operation 614 can be used to monitor additional features within the organization, for example new hardware or a changed set of monitoring parameters that would be capable of detecting the newly-identified threat. The new monitoring action operation 614 allows a user to update the specific events to be monitored and recorded to ensure as complete a view of accesses to the organization's electronic footprint as possible.

If the threat assessment operation 612 does not detect any additional potential threats, the new threat operation 614 need not be performed; rather, any existing threats can be addressed and responded to via a response operation 616. The response operation 616 performs the one or more mitigating actions defined by the business rules, including, for example, suspending operation of one or more computing systems, generating alerts, limiting physical or electronic access to data or computing systems to particular individuals or groups, or other response measures. Additionally, response operation 616 can include not only incident response, but also suggested training or post-incident review of the detected threat or event, to prevent recurrence of that event.

A report generation operation 618 generates reports, dashboards of realtime monitoring status, or other views on the monitored organization based on the monitoring records gathered. Various types of reports could be generated, such as vulnerability mitigation strategy reports, mitigation effectiveness reports, risk assessments, or system alerts. In certain embodiments, the report generation operation 618 associates the report with one or more individuals (e.g., a community of interest) including individuals within and external to the organization, to allow for collaborative risk assessment and response. In one example embodiment, a risk readiness index report can be generated for use by the organization, either within the report generation operation 618 or the threat assessment operation 612 (or a combination thereof), and others outside the organization, to determine a measured readiness against cube-attacks or other electronic data vulnerabilities.

A report communication operation 620 communicates the generated reports to one or more individuals within a community of interest, where the community of interest represents a group of individuals affiliated with an organization but can include individuals both within and external to the organization, and where each of the individuals represents a common audience. In certain embodiments, the report communication operation transmits reports and/or dashboard to users within a particular group of users, or community of interest, using secure communications software, such as Stealth software as discussed above. In such embodiments, reports can be communicated across departments within an organization, and to individuals outside the organization, without risking compromise of that data.

An end operation 622 generally signifies completed monitoring or operation of the security software and secure communication software within the organization's electronic footprint.

Although the operations 602-622 are described in one example order in FIG. 6, it is understood that a variety of other orders of operations could be used as well. Furthermore, additional operations can be performed within the method 600, and in some embodiments certain operations from among the operations 602-622 can be eliminated as well.

Referring to FIG. 7, a method 700 for establishing secure communication of reports regarding cyberspace and electronic data vulnerabilities is disclosed, according to a possible embodiment of the present disclosure. The method 700 generally can be used within a collaboration platform, such as illustrated in FIG. 4, above, to establish groups of individuals intended to receive reports regarding the security status of one or more organizations. In comparison to the method 600 of FIG. 6, method 700 generally relates to an overall organizational scheme in which multiple organizations can be included, to allow for monitoring useable to detect coordinated, multiprong/multi-entity cube-attacks or other electronic or physical organizational vulnerabilities.

The method 700 is initiated at a start operation 702, which generally corresponds to initial availability of monitoring data from one or more organizations associated with security software and/or the collaboration platform described above. A community of interest operation 704 defines a plurality of communities of interest, with each community of interest including individuals having a common characteristic or representing a common audience; an example community of interest could include a particular external department, individuals having a common security clearance (e.g., “top secret security clearance”), media members, public relations staff or other internal departments, or other groups.

A data vulnerabilities operation 706 defines the data vulnerabilities to be considered based on the gathered information in the monitoring data. The data vulnerabilities operation 706 can include, for example, defining reporting layouts for the various communities of interest, with reporting layouts being a view of possible vulnerabilities in one or more organizations based on monitoring data and other observed vulnerabilities in the same or different organizations. A report processing operation 708 generates reports corresponding to the data vulnerabilities, with each report being tailored to the particular audience (i.e., community of interest) to which it is directed.

A secure communication session operation 710 corresponds generally to a user attempting to validate him/herself to secured software within the organizational footprint, to allow that user to access data and/or reports based on that data. In certain embodiments, the secure communication session operation 710 establishes a secure communication session (e.g., a Stealth-enabled secure communication connection) based on a trusted, personal authentication of that user (e.g., using biometric data or other information unique to that user and not replicable by another individual).

A data access operation 712 occurs upon authentication of the user and establishment of a secure communication session. The data access operation 712 grants the user access to data/reports that are defined to be “of interest” to that user; in other words, the data access operation 712 provides the user with appropriate decryption keys to (1) establish a cryptographically-secured connection to monitoring data/reports, and (2) decrypt the cryptographically-stored monitoring data. In conjunction with the Stealth-enabled aspects of the present disclosure, the user is only capable of accessing and viewing data, and securely connecting to computing systems, which are affiliated with that user's community of interest, thereby controlling at a group level the access rights to each user, irrespective of that user's role (or lack of a role) within an organization.

A reporting operation 714 generates and displays reports to the user based on the accessed data. While the secure communication session for each user is active, the reporting operation 714 can provide reports (either static, predefined reports or interactive reports generated based on the monitoring data) for viewing by a user, such as those discussed above with respect to FIG. 6.

Generally, the secure communication session operation 710, data access operation 712, and reporting operation 714 can execute in sequence and multiple instances may occur concurrently, with each user performing an authentication, secure connection, and data/report access sequence to view collaborative reports across one or more organization's electronic footprints. Earlier described operations 702-708 may occur in sequence with or in parallel to user access. An end operation 716 signifies completed user access to reports (for one or all users) and closing secured connections to the collaborative reporting data.

Referring now to FIGS. 1-7 overall, it is recognized that the collaboration platform and secured systems described herein provide a number of advantages for detecting and responding to organized attacks on an organization, and in particular cube-attacks. In particular, the systems described herein manage both physical and electronic vulnerabilities of an organization, while allowing secured data sharing across organizations to users having a common interest (e.g., common security level clearance). This improves recognition of attacks by providing a coordinated view of data or physical access attempts across one or more entities by individuals both within and external to the entities, and allows for quicker response to such attacks by including predefined and user-definable responses to such attacks.

The above specification, examples and data provide a complete description of the manufacture and use of the composition of the invention. Since many embodiments of the invention can be made without departing from the spirit and scope of the invention, the invention resides in the claims hereinafter appended.

1. A method of securing an organization against cyberspace vulnerabilities, the method comprising:
receiving a definition of physical and logical locations of data managed by the organization;
receiving a definition of one or more business rules representing detected circumstances under which the data may be compromised;
monitoring the data based on the business rules and definition of the physical and logical locations of data to detect a cyberspace or electronic data vulnerability;
generating one or more reports based on monitoring the data and relating at least in part to access of the data; and
communicating, via a secure communications module, the one or more reports to an individual included within a community of interest, the secure communications module cryptographically securing the one or more reports using an encryption key associated with the community of interest.

2. The method of claim 1, wherein defining the physical and logical locations of data includes defining known data vulnerabilities within the organization.

3. The method of claim 1, wherein the organization includes a governmental organization.

4. The method of claim 1, further comprising defining one or more response plans to be executed in response to detection of a cyberspace or electronic data vulnerability.

5. The method of claim 4, further comprising, upon detection of a cyberspace or electronic data vulnerability, executing a response plan associated with the detected cyberspace or electronic data vulnerability.

6. The method of claim 1, further comprising:
while monitoring, determining an existence of one or more additional circumstances under which data may be compromised; and
defining one or more additional business rules representing the one or more additional circumstances.

7. The method of claim 1, wherein the circumstances under which the data may be compromised are selected from the group consisting of:
cyberspace attacks;
unauthorized user access to organizational data;
environmental threats;
unauthorized wireless communication in protected areas; and
damage to physical facilities.

8. The method of claim 1, further comprising, prior to communicating the one or more reports to the individual, personally authenticating the individual using credentials uniquely associated with the individual.

9. The method of claim 8, wherein the credentials uniquely associated with the individual include biometric data.

10. A method of operating a security system associated with an organization, the security system configured to protect against cyberspace and electronic data vulnerabilities, the method comprising:
defining one or more physical and logical locations of data managed by the organization;
defining one or more business rules representing detected circumstances under which the data may be compromised;
submitting authentication information of a user to personally authenticate the user using credentials uniquely associated with the user;
upon authentication of the user, establishing a secure communication connection between a computing device operated by the user and a report engine, the secure communication connection providing cryptographic security between the computing device and the report engine and using an encryption key associated with a community of interest including the user; and
receiving, via the secure communication connection, one or more reports based on monitoring the data based on the business rules and definition of the physical and logical locations of data, the one or more reports including information regarding detected cyberspace and electronic data vulnerabilities and encrypted by the encryption key.

11. The method of claim 10, further comprising defining one or more communities of interest useable by the secure communication connection, the one or more communities of interest each associated with a different encryption key.

12. The method of claim 10, wherein the authentication information includes biometric data associated with the user.

13. The method of claim 10, further comprising defining a plurality of response plans to be executed in response to detection of a cyberspace or electronic data vulnerability.

14. The method of claim 10, wherein the plurality of reports includes reports selected from the group consisting of:
vulnerability mitigation strategy reports;
vulnerability mitigation process reports;
risk assessments; and
system alerts.

15. The method of claim 14, wherein the plurality of communities of interest are selected from one or more groups consisting of:
state government organizations;
at least partially public sector organizations;
intelligence organizations; and
executive departments.

16. A method of monitoring vulnerability of an organization against cyberspace and electronic data attacks, the method comprising:
receiving, via a secure communications module, one or more reports based on monitoring of sensitive data affiliated with an organization and relating at least in part to access of the sensitive data;
wherein the sensitive data is monitored across a network affiliated by the organization to detect a cyberspace or electronic data vulnerability; and
wherein the one or more reports are communicated to an individual included within a community of interest defined using a secure communications module, the secure communications module cryptographically securing the one or more reports using an encryption key associated with the community of interest.

17. The method of claim 16, wherein the cyberspace or electronic data vulnerability is detected based on a definition of physical and logical locations of data managed by the organization as well as one or more business rules representing detected circumstances under which the data may be compromised.

18. The method of claim 16, further comprising, prior to receiving the one or more reports, personally authenticating an individual as being a member of the community of interest.

19. The method of claim 16, wherein the one or more reports are generated by a situational awareness application.

20. The method of claim 16, wherein the community of interest is included within a plurality of communities of interest, and wherein the plurality of communities of interest are each associated with a different encryption key.
